(19) United States
(12) Patent Application Publication
(10) Pub. No.: US 2026/0087990 A1
(43) Pub. Date: Mar. 26, 2026

(54) PIXEL CIRCUIT AND DISPLAY DEVICE INCLUDING PIXEL CIRCUIT

(71) Applicant: ELECTRONICS AND TELECOMMUNICATIONS RESEARCH INSTITUTE, Daejeon (KR)

(72) Inventors: Yongduck KIM, Daejeon (KR); Kukjoo KIM, Daejeon (KR); Chunwon BYUN, Daejeon (KR); Dae Hyun AHN, Daejeon (KR); Wooseup YOUM, Daejeon (KR); Hyunsu CHO, Daejeon (KR); Chul Woong JOO, Daejeon (KR)

(73) Assignee: ELECTRONICS AND TELECOMMUNICATIONS RESEARCH INSTITUTE, Daejeon (KR)

(21) Appl. No.: 19/336,038

(22) Filed: Sep. 22, 2025

(30) Foreign Application Priority Data
Sep. 24, 2024 (KR) 10-2024-0129151
Jul. 3, 2025 (KR) 10-2025-0089279

(51) Int. Cl. G09G 3/3233

(52) U.S. Cl. CPC G09G 3/3233; G09G 2330/021

(57) ABSTRACT

A pixel circuit includes a first transistor with a gate connected to a scan line, a first terminal connected to a data line, and a second terminal, a second transistor with a gate connected to the second terminal of the first transistor, a first terminal connected to a power node to which a power supply voltage is supplied, and a second terminal, a third transistor with a gate, a first terminal connected to the second terminal of the second transistor, and a second terminal, a first capacitor connected between the second terminal of the first transistor and the second terminal of the second transistor, and an organic light-emitting diode connected between the second terminal of the second transistor and a first ground node. A current of the organic light-emitting diode is determined by a difference between a current of the second transistor and a current of the third transistor.

### CROSS-REFERENCE TO RELATED APPLICATIONS

This application claims priority under 35 U.S.C. § 119 to Korean Patent Application No. 10-2024-0129151 filed on Sep. 24, 2024, and Korean Patent Application No. 10-2025-0089279 filed on Jul. 3, 2025, in the Korean Intellectual Property Office, the disclosures of which are incorporated by reference herein in their entireties.

### BACKGROUND

The present disclosure relates to a display device, and more particularly, to a pixel circuit for accurately expressing a low grayscale and a display device including the pixel circuit.

A display device may include a plurality of pixels. The plurality of pixels may be arranged in rows and columns. The rows of the plurality of pixels may be connected to a gate driver, and the columns of the plurality of pixels may be connected to a data driver. The gate driver may control the timing for selecting each of the rows of the plurality of pixels. The data driver may adjust the brightness of the pixels in the selected row.

The amount of current supplied to the plurality of pixels is adjusted according to the applied voltage, and the brightness is adjusted based on the amount of current. That is, in each of the plurality of pixels, a driving transistor may adjust the brightness of an OLED element by adjusting the current supplied to the OLED element. However, the plurality of pixels may have difficulty expressing a low grayscale due to various noises, such as junction leakage current, white noise, and gate leakage current, which are included in the current of the driving transistor.

Accordingly, there is a need for a display device that can accurately express a low grayscale.

### SUMMARY

An object of the present disclosure is to provide a pixel circuit for accurately expressing a low grayscale and a display device including the pixel circuit.

A pixel circuit according to the present disclosure includes a first transistor including a gate connected to a scan line, a first terminal connected to a data line, and a second terminal, a second transistor including a gate connected to the second terminal of the first transistor, a first terminal connected to a power node to which a power supply voltage is supplied, and a second terminal, a third transistor including a gate, a first terminal connected to the second terminal of the second transistor, and a second terminal, a first capacitor connected between the second terminal of the first transistor and the second terminal of the second transistor, and an organic light-emitting diode (OLED) connected between the second terminal of the second transistor and a first ground node. A current of the OLED is determined by a difference between a current of the second transistor and a current of the third transistor

According to an embodiment of the present disclosure, the gate of the third transistor receives a low current generation voltage.

According to an embodiment of the present disclosure, a voltage of the scan line is adjusted to a first voltage in a first period and adjusted to a second voltage in a second period, the low current generation voltage is maintained at a third voltage in the first period and the second period.

According to an embodiment of the present disclosure, the third voltage has a level between a level of the first voltage and a level of the second voltage.

According to an embodiment of the present disclosure, in the first period, the first transistor, the second transistor, and the third transistor are turned on. In the second period, the first transistor is turned off, and the second transistor and the third transistor are turned on.

According to an embodiment of the present disclosure, the pixel circuit further includes a fourth transistor including a gate connected to the scan line, a first terminal connected to an LCG line, and a second terminal connected to the gate of the third transistor, and a second capacitor connected between the second terminal of the third transistor and the second terminal of the fourth transistor.

According to an embodiment of the present disclosure, the third transistor operates based on a voltage of the LCG line.

According to an embodiment of the present disclosure, a voltage of the scan line is adjusted to a first voltage in a first period and adjusted to a second voltage in a second period. A voltage of the LCG line is adjusted to a third voltage in the first period and adjusted to the second voltage in the second period.

According to an embodiment of the present disclosure, the third voltage has a level between a level of the first voltage and a level of the second voltage.

According to an embodiment of the present disclosure, in the first period, the first transistor, the second transistor, the third transistor, and the fourth transistor are turned on. In the second period, the first transistor and the fourth transistor are turned off, and the second transistor and the third transistor are turned on.

According to an embodiment of the present disclosure, the gate of the third transistor is connected to a control line. The second terminal of the third transistor is connected to an external line.

According to an embodiment of the present disclosure, a voltage of the scan line is adjusted to a first voltage in a first period and adjusted to a second voltage in a second period. A voltage of the control line is adjusted to the first voltage in the first period and adjusted to a third voltage in the second period. A voltage of the external line is adjusted to a fourth voltage in the first period and adjusted to the second voltage in the second period.

According to an embodiment of the present disclosure, the third voltage has a level between a level of the first voltage and a level of the second voltage.

According to an embodiment of the present disclosure, in the first period, the first transistor, the second transistor, and the third transistor are turned on. In the second period, the first transistor is turned off, and the second transistor and the third transistor are turned on.

According to an embodiment of the present disclosure, in the second period, a current of the third transistor is output externally through the external line.

A display device according to the present disclosure includes pixels arranged in rows and columns, a gate driver connected to the rows of the pixels through first conductive lines and second conductive lines, and a data driver connected to the columns of the pixels through third conductive lines. Each of the pixels includes a first transistor including a gate connected to a corresponding first conductive line among the first conductive lines, a first terminal connected to a corresponding third conductive line among the third conductive lines, and a second terminal, a second transistor including a gate connected to the second terminal of the first transistor, a first terminal connected to a power node to which a power supply voltage is supplied, and a second terminal, a third transistor including a gate, a first terminal connected to the second terminal of the second transistor, and a second terminal, a first capacitor connected between the second terminal of the first transistor and the second terminal of the second transistor, and an organic light-emitting diode (OLED) connected between the second terminal of the second transistor and a first ground node. A current of the OLED is determined by a difference between a current of the second transistor and a current of the third transistor.

According to an embodiment of the present disclosure, the gate of the third transistor receives a low current generation voltage. A voltage of the corresponding first conductive line among the first conductive lines is adjusted to a first voltage in a first period and adjusted to a second voltage in a second period. The low current generation voltage is maintained at a third voltage in the first period and the second period.

According to an embodiment of the present disclosure, the data driver is further connected to the columns of the pixels through fourth conductive lines.

According to an embodiment of the present disclosure, each of the pixels further includes a fourth transistor including a gate connected to the corresponding first conductive line among the first conductive lines, a first terminal connected to a corresponding fourth conductive line among the fourth conductive lines, and a second terminal connected to the gate of the third transistor, and a second capacitor connected between the second terminal of the third transistor and the second terminal of the fourth transistor. A voltage of the corresponding first conductive line among the first conductive lines is adjusted to a first voltage in a first period and adjusted to a second voltage in a second period. A voltage of the corresponding fourth conductive line among the fourth conductive lines is adjusted to a third voltage in the first period and adjusted to the second voltage in the second period.

According to an embodiment of the present disclosure, the gate of the third transistor is connected to a corresponding second conductive line among the second conductive lines. The second terminal of the third transistor is connected to a corresponding fourth conductive line among the fourth conductive lines. A voltage of the corresponding first conductive line among the first conductive lines is adjusted to a first voltage in a first period and adjusted to a second voltage in a second period. A voltage of the corresponding second conductive line among the second conductive lines is adjusted to the first voltage in the first period and adjusted to a third voltage in the second period. A voltage of the corresponding fourth conductive line among the fourth conductive lines is adjusted to a fourth voltage in the first period and adjusted to the second voltage in the second period.

### BRIEF DESCRIPTION OF THE FIGURES

The above and other objects and features of the present disclosure will become apparent by describing in detail embodiments thereof with reference to the accompanying drawings.

FIG. 1 illustrates an example of a display device according to an embodiment of the present disclosure.

FIG. 2 illustrates an example of a first pixel.

FIG. 3 illustrates a current of the second transistor of the first pixel of FIG. 2.

FIG. 4 illustrates a change in current of the organic light-emitting diode corresponding to a change in data line voltage of the first pixel of FIG. 2.

FIG. 5 illustrates an example of a second pixel.

FIG. 6 illustrates currents of the second transistor, the third transistor, and the organic light-emitting diode of the second pixel of FIG. 5.

FIG. 7 illustrates changes in a current of the second transistor and a current of the organic light-emitting diode corresponding to a change in data line voltage of the second pixel of FIG. 5.

FIG. 8 illustrates an example of signals for controlling the second pixel of FIG. 5 to express a low grayscale.

FIG. 9 illustrates an example of a third pixel.

FIG. 10 illustrates an example of signals for controlling the third pixel of FIG. 9 to express a low grayscale.

FIG. 11 illustrates an example of a fourth pixel.

FIG. 12 illustrates an example of signals for controlling the fourth pixel of FIG. 11 to express a low grayscale.

### DETAILED DESCRIPTION

Hereinafter, embodiments of the present disclosure may be described in detail and clearly to such an extent that an ordinary one in the art easily implements the present disclosure.

Hereinafter, the preferred embodiments of the present disclosure will be described in detail with reference to the accompanying drawings. The advantages, features, and methods of achieving the present invention will become more apparent from the following detailed description taken in conjunction with the accompanying drawings. However, it should be understood that the present invention is not limited to the embodiments described herein and may be embodied in various other forms. Rather, the embodiments introduced here are provided to make the disclosed content thorough and complete, and to ensure that the concepts of the disclosure are sufficiently conveyed to those skilled in the art, and the disclosure is defined only by the scope of the claims. Throughout the specification, the same reference numerals refer to the same components.

The terms used in the specification are for the purpose of describing the embodiments and are not intended to limit the disclosure. In this specification, the singular form includes the plural form unless specifically stated otherwise in the context. The terms ‘comprise’ and/or ‘comprising’ used in the specification do not exclude the presence or addition of one or more other components, actions, and/or elements. Furthermore, since it is based on preferred embodiments, the reference numerals presented in the description are not necessarily limited by the order of presentation.

The embodiments described in this specification will be explained with reference to ideal examples such as cross-sectional and/or plan views of the disclosure. In the drawings, the thickness of the layers and regions may be exaggerated for the effective explanation of the technical content. Therefore, the shape of the example may be altered due to manufacturing techniques and/or tolerances. Thus, the embodiments of the present disclosure are not limited to the specific forms illustrated, but include changes in the shape created according to the manufacturing process.

Components that are described in the detailed description with reference to the terms “unit”, “module”, “block”, “˜er or ˜or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof

In the present disclosure, each of the phrases such as “A or B,” “at least one of A and B,” “at least one of A or B,” “A, B, or C,” “at least one of A, B, and C,” and “at least one of A, B, or C” is intended to encompass any one of the listed elements and all possible combinations thereof.

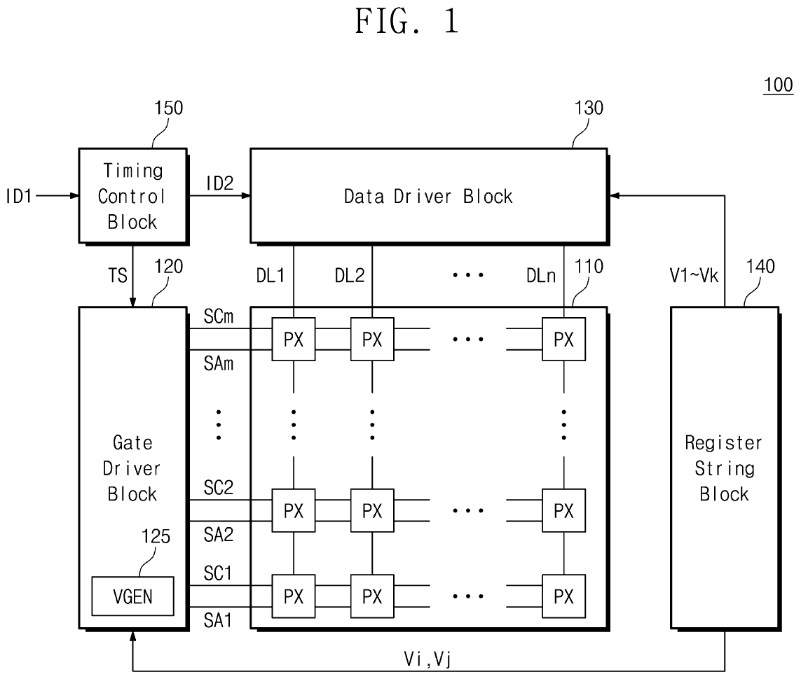

FIG. 1 illustrates an example of a display device according to an embodiment of the present disclosure. Referring to FIG. 1, a display device 100 may include a pixel array 110, a gate driver block 120, a data driver block 130, a resistor string block 140, and a timing control block 150.

The pixel array 110 may include pixels PX arranged in rows and columns. The rows of the pixels PX may be connected to first conductive lines and second conductive lines, respectively. For example, the first conductive lines may include first to m-th scan lines SC1 to SCm. The second conductive lines may include first to m-th control lines SA1 to SAm. The columns of the pixels PX may be connected to third conductive lines. For example, the third conductive lines may include first to n-th data lines DL1 to DLn.

Each of the pixels PX may be implemented to adjust brightness in response to control from a corresponding scan line among the first to m-th scan lines SC1 to SCm, a corresponding control line among the first to m-th control lines SA1 to SAm, and the first to n-th data lines DL1 to DLn. For example, each of the pixels PX may include a light-emitting element such as a light-emitting diode or an organic light-emitting diode, and transistors that control the light-emitting element.

The gate driver block 120 may be connected to the rows of the pixels PX through the first to m-th scan lines SC1 to SCm and through the first to m-th control lines SA1 to SAm. The gate driver block 120 may sequentially select the rows of the pixels PX through the first to m-th scan lines SC1 to SCm in response to control (e.g., a timing signal TS) from the timing control block 150.

The gate driver block 120 may control the brightness or the light-emission timings of the pixels PX through the first to m-th control lines SA1 to SAm in response to control (e.g., the timing signal TS) from the timing control block 150. The gate driver block 120 may include a voltage generator (VGEN) 125. The voltage generator 125 may generate voltages (e.g., control line voltages) to be supplied to the first to m-th control lines SA1 to SAm based on at least two voltages Vi, Vj received from the resistor string block 140.

The voltage generator 125 may generate two or more different control line voltages. The gate driver block 120 may select one of the two or more different control line voltages and apply the selected control line voltage to the first to m-th control lines SA1 to SAm. For example, the gate driver block 120 may supply the same control line voltage to the first to m-th control lines SA1 to SAm or may supply the two or more different control line voltages to different control lines.

The data driver block 130 may receive second image data ID2 from the timing control block 150. The second image data ID2 may include brightness information of the pixels of one row. The data driver block 130 may apply data line voltages to the first to n-th data lines DL1 to DLn in response to control from the timing control block 150. The data driver block 130 may output the brightness information input to the pixels of the selected row as the data line voltages based on the second image data ID2.

The data driver block 130 may receive first to k-th voltages V1 to Vk from the resistor string block 140. The data driver block 130 may select one of the first to k-th voltages V1 to Vk based on the brightness information of a specific pixel of the selected row included in the second image data ID2. The data driver block 130 may supply the selected voltage to the specific pixel of the selected row through a corresponding data line.

The resistor string block 140 may include a plurality of resistors connected between two voltages (e.g., reference voltages). The resistor string block 140 may provide voltages between the resistors to the data driver block 130 as the first to k-th voltages V1 to Vk. Additionally, the resistor string block 140 may provide the at least two voltages Vi, Vj among the first to k-th voltages V1 to Vk to the gate driver block 120.

The timing control block 150 may control operation timings of the gate driver block 120 through the timing signal TS. The timing control block 150 may receive first image data ID1 from an external device. The timing control block 150 may provide the first image data ID1 to the data driver block 130 as second image data ID2, either converted into a form suitable for display or unconverted.

In an embodiment, the gate driver block 120 has been described as being connected to the rows of the pixels PX through the first to m-th scan lines SC1 to SCm and the first to m-th control lines SA1 to SAm. However, the gate driver block 120 may be implemented to be connected to the rows of the pixels PX through additional lines or a smaller number of lines.

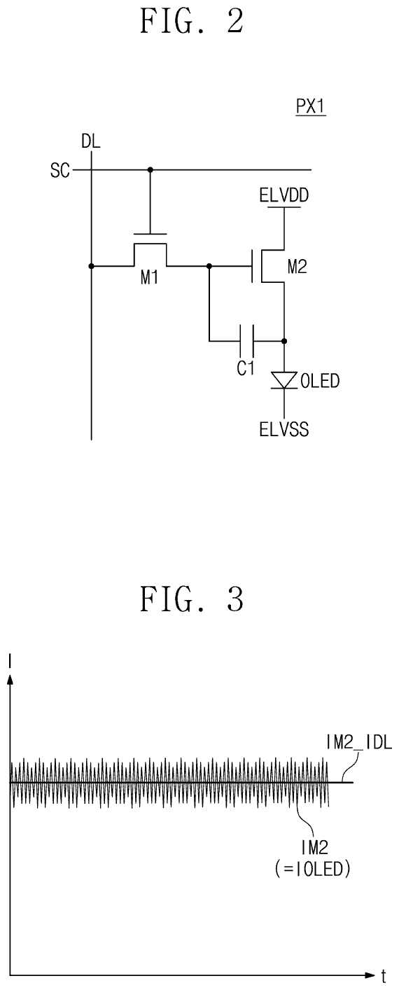

FIG. 2 illustrates an example of a first pixel. Referring to FIG. 1 and FIG. 2, a first pixel PX1 may include a first transistor M1 that includes a gate connected to a scan line SC, a first terminal connected to a data line DL, and a second terminal.

The first pixel PX1 may further include a second transistor M2 that includes a gate connected to the second terminal of the first transistor M1, a first terminal connected to a power node to which a power supply voltage ELVDD is supplied, and a second terminal.

The first pixel PX1 may further include a first capacitor C1 connected between the second terminal of the first transistor M1 and the second terminal of the second transistor M2. The first pixel PX1 may further include an organic light-emitting diode OLED connected between the second terminal of the second transistor M2 and a first ground node to which a ground voltage ELVSS is supplied.

In an embodiment, when the pixel array 110 is implemented with the first pixel PX1, the first to m-th control lines SA1 to SAm may be omitted.

In an embodiment, when modeling the first pixel PX1, the first transistor M1 may be modeled as a switch that is turned on or off by a voltage of the scan line SC, and the second transistor M2 may be modeled as a dependent current source controlled by the power supply voltage ELVDD.

In an embodiment, the ground voltage ELVSS is used as a common ground voltage in the pixel array 110 and may be different from a ground voltage of the display device 100. For example, the ground voltage ELVSS may have a negative potential lower than 0V or a positive potential higher than 0V. The power supply voltage ELVDD is used as a common power supply voltage in the pixel array 110 and may be different from a power supply voltage of the display device 100. For example, the power supply voltage ELVDD may be a voltage higher than the ground voltage ELVSS.

FIG. 3 illustrates a current of the second transistor of the first pixel of FIG. 2. In FIG. 3, the horizontal axis represents time, and the vertical axis represents the amount of current. In FIG. 3, a current IM2_IDL is assumed to represent the ideal current of the second transistor M2.

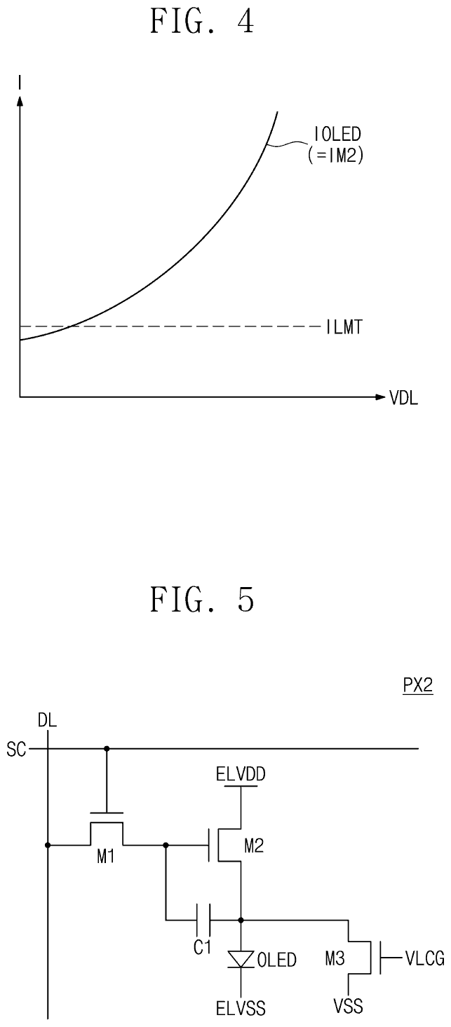

FIG. 4 illustrates a change in current of the organic light-emitting diode corresponding to a change in data line voltage of the first pixel of FIG. 2. In FIG. 4, the horizontal axis represents a data line voltage VDL, and the vertical axis represents the amount of current.

Referring to FIGS. 2 to 4, in the first pixel PX1, a current IM2 of the second transistor M2 may be provided to the organic light-emitting diode OLED as the current IOLED of the organic light-emitting diode OLED. That is, brightness of the organic light-emitting diode OLED may be adjusted by the current IM2 of the second transistor M2. When expressing a low grayscale using the first pixel PX1, the current IM2 of the second transistor M2 may include noise such as junction leakage current, white noise, and gate leakage current. As a result, the organic light-emitting diode OLED may have difficulty accurately expressing the low grayscale.

Furthermore, when the organic light-emitting diode OLED expresses the low grayscale, the second transistor M2 may operate in a sub-threshold region rather than a saturation region. In this case, because change in current IM2 with respect to the data line voltage VDL is large, it may be difficult to express the low grayscale with current level lower than a limit current ILMT, which is the criterion for determining the feasibility of implementation by the organic light-emitting diode OLED.

FIG. 5 illustrates an example of a second pixel. Referring to FIG. 1 and FIG. 5, a second pixel PX2 may include a first transistor M1 including a gate connected to a scan line SC, a first terminal connected to a data line DL, and a second terminal.

The second pixel PX2 may further include a second transistor M2 including a gate connected to the second terminal of the first transistor M1, a first terminal connected to a power node to which a power supply voltage ELVDD is supplied, and a second terminal.

The second pixel PX2 may further include a third transistor M3 including a gate to which a low current generation voltage VLCG is transmitted, a first terminal connected to the second terminal of the second transistor M2, and a second terminal connected to a second ground node to which a ground voltage VSS is supplied. In an embodiment, the low current generation voltage VLCG may represent a voltage for generating a low current or a voltage provided to express a low grayscale.

The second pixel PX2 may further include a first capacitor C1 connected between the second terminal of the first transistor M1 and the second terminal of the second transistor M2. The second pixel PX2 may further include an organic light-emitting diode OLED connected between the second terminal of the second transistor M2 and a first ground node to which a ground voltage ELVSS is supplied.

In an embodiment, when the pixel array 110 is implemented with the second pixel PX2, the first to m-th control lines SA1 to SAm may be omitted.

In an embodiment, when modeling the second pixel PX2, the first transistor M1 may be modeled as a switch that is turned on or off by a voltage of the scan line SC, the second transistor M2 may be modeled as a dependent current source controlled by the power supply voltage ELVDD, and the third transistor M3 may be modeled as a dependent current source controlled by the low current generation voltage VLCG.

In an embodiment, the low current generation voltage VLCG may be provided in common to the pixel array 110. That is, the pixel array 110 may share the low current generation voltage VLCG.

In an embodiment, the low current generation voltage VLCG may be provided from the blocks 120, 130, 140, 150 or from a separate logic that is separate from the blocks 120, 130, 140, 150.

In an embodiment, the ground voltage VSS may have a negative potential lower than 0V or a positive potential higher than 0V. In an embodiment, the ground voltage VSS may have the same potential as the ground voltage ELVSS. In an embodiment, the ground voltage VSS may have a different potential from the ground voltage ELVSS.

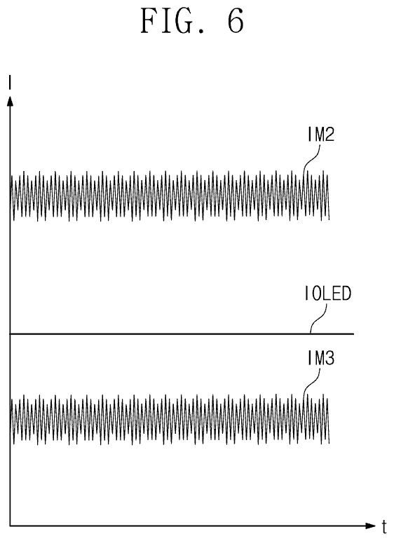

FIG. 6 illustrates currents of the second transistor, the third transistor, and the organic light-emitting diode of the second pixel of FIG. 5. In FIG. 6, the horizontal axis represents time, and the vertical axis represents the amount of current.

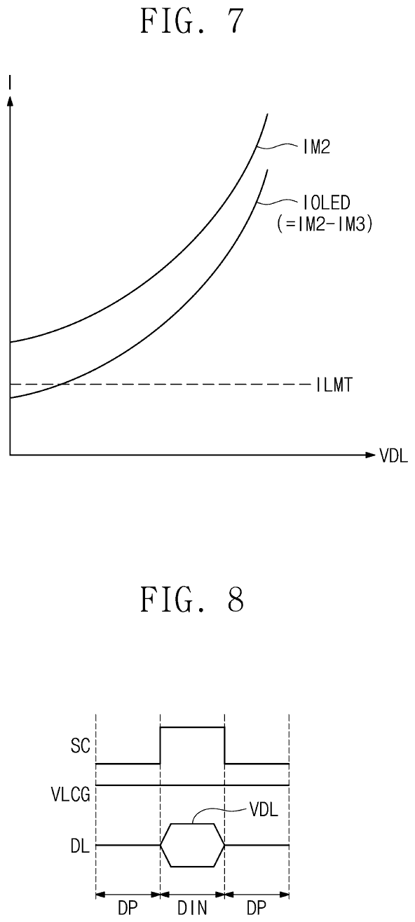

FIG. 7 illustrates changes in a current of the second transistor and a current of the organic light-emitting diode corresponding to a change in data line voltage of the second pixel of FIG. 5. In FIG. 7, the horizontal axis represents a data line voltage VDL, and the vertical axis represents the amount of current.

Referring to FIGS. 5 to 7, a current IM2 of the second transistor M2 may be provided to the organic light-emitting diode OLED and the third transistor M3. That is, the current IM2 of the second transistor M2 may be equal to the sum of a current IOLED of the organic light-emitting diode OLED and a current IM3 of the third transistor M3.

The second transistor M2 and the third transistor M3 may be adjacent to each other and fabricated with the same size. Therefore, when a low grayscale (e.g., the lowest grayscale or 1 gray level) is expressed through the second pixel PX2, the current IM2 of the second transistor M2 and the current IM3 of the third transistor M3 may include noise of the same or similar magnitude. The current IOLED of the organic light-emitting diode OLED may be determined by the difference between the current IM2 of the second transistor M2 and the current IM3 of the third transistor M3. Therefore, the noise in the current IOLED of the organic light-emitting diode OLED is canceled, and the second pixel PX2 can express a low grayscale regardless of the noise.

FIG. 8 illustrates an example of signals for controlling the second pixel of FIG. 5 to express a low grayscale. Referring to FIGS. 1, 5, and 8, in a data input period DIN, that is, when a row of the second pixel PX2 is selected, a voltage of the scan line SC may be adjusted from a low level (e.g., a first level or a turn-off level) to a high level (e.g., a second level or a turn-on level). Therefore, the first transistor M1 may be turned on.

In the data input period DIN, a data line voltage VDL may be transmitted to the second pixel PX2 through the data line DL. The data line voltage VDL may correspond to one of first to k-th voltages V1 to Vk. The data line voltage VDL is transmitted to the gate of the second transistor M2 through the first transistor M1 and may be charged in the first capacitor C1. Therefore, the second transistor M2 may be turned on.

In a display period DP, the voltage of the scan line SC may be adjusted from the high level to the low level. Therefore, the first transistor M1 is turned off, and the voltage charged in the first capacitor C1 may be maintained.

In the data input period DIN and the display period DP, a low current generation voltage VLCG may be transmitted to the gate of the third transistor M3. The low current generation voltage VLCG may be set to have a constant voltage level (e.g., a third level). Therefore, in the data input period DIN and the display period DP, the third transistor M3 is turned on, and a current IM3 may continuously flow through the third transistor M3. In an embodiment, the low current generation voltage VLCG may have a voltage level between the low level and the high level. That is, the low current generation voltage VLCG may be a voltage higher than the ground voltage ELVSS or the ground voltage VSS.

In an embodiment, the low current generation voltage VLCG in FIG. 8 may be equal to or less than the data line voltage VDL. This may mean that the low current generation voltage VLCG is a voltage that makes a current IM3 of the third transistor M3 equal to or less than a current IM2 of the second transistor M2 (IM2≥IM3).

The current IM2 of the second transistor M2 may be provided to the organic light-emitting diode OLED and the third transistor M3. That is, the current IM2 of the second transistor M2 may be equal to the sum of a current IOLED of the organic light-emitting diode OLED and the current IM3 of the third transistor M3. Therefore, the current IOLED of the organic light-emitting diode OLED may be determined by a difference between the current IM2 of the second transistor M2 and the current IM3 of the third transistor M3.

Meanwhile, in the data input period DIN and the display period DP, even if the third transistor M3 is turned on, the power consumption increased by the current IM3 of the third transistor M3 may be insignificant. For example, if a high grayscale current is 10 nA and a low grayscale current is 10 pA, a current ratio is 1000:1, so the power consumption increased by the current IM3 may be about 0.1% of total power consumption.

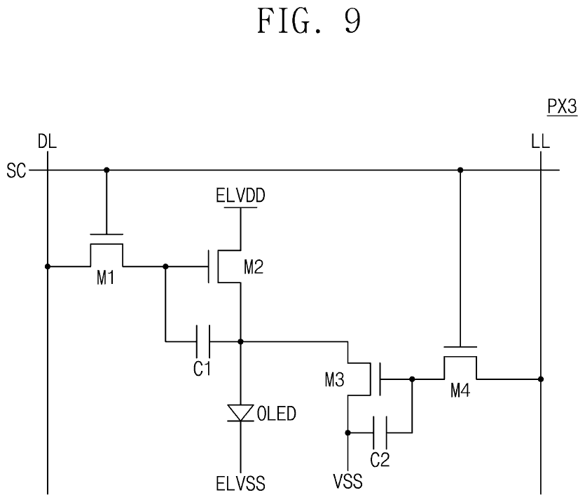

FIG. 9 illustrates an example of a third pixel. Referring to FIG. 1 and FIG. 9, a third pixel PX3 may include a first transistor M1 including a gate connected to a scan line SC, a first terminal connected to a data line DL, and a second terminal.

The third pixel PX3 may further include a second transistor M2 including a gate connected to the second terminal of the first transistor M1, a first terminal connected to a power node to which a power supply voltage ELVDD is supplied, and a second terminal.

The third pixel PX3 may further include a third transistor M3 including a gate connected to a second terminal of a fourth transistor M4, a first terminal connected to the second terminal of the second transistor M2, and a second terminal connected to a second ground node to which a ground voltage VSS is supplied.

In an embodiment, the ground voltage VSS may have a negative potential lower than 0V or a positive potential higher than 0V. In an embodiment, the ground voltage VSS may have the same potential as a ground voltage ELVSS. In an embodiment, the ground voltage VSS may have a different potential from the ground voltage ELVSS.

The third pixel PX3 may further include the fourth transistor M4 including a gate connected to the scan line SC, a first terminal connected to an LCG line LL, and the second terminal connected to the gate of the third transistor M3.

The fourth transistor M4 may receive a low current generation voltage VLCG through the LCG line LL. In an embodiment, different LCG lines may be provided for columns of the pixels PX. In an embodiment, the LCG line LL may be provided to the timing control block 150 or to a separate logic that is separate from the timing control block 150. For example, the display device 100 may further include an LCG block not shown. The LCG line LL may be controlled by the LCG block.

The third pixel PX3 may further include a first capacitor C1 connected between the second terminal of the first transistor M1 and the second terminal of the second transistor M2. The third pixel PX3 may further include a second capacitor C2 connected between the second terminal of the third transistor M3 and the second terminal of the fourth transistor M4. The third pixel PX3 may further include an organic light-emitting diode OLED connected between the second terminal of the second transistor M2 and a first ground node to which the ground voltage ELVSS is supplied.

In an embodiment, when the pixel array 110 is implemented with the third pixel PX3, the first to m-th control lines SA1 to SAm may be omitted.

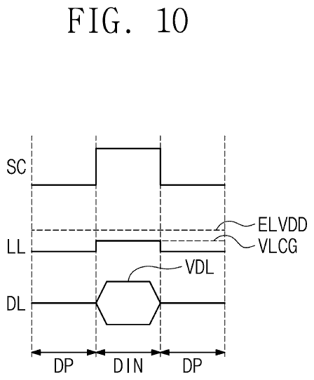

FIG. 10 illustrates an example of signals for controlling the third pixel of FIG. 9 to express a low grayscale. Referring to FIGS. 1, 9, and 10, in a data input period DIN, that is, when a row of the third pixel PX3 is selected, a voltage of the scan line SC may be adjusted from a low level (e.g., a first level or a turn-off level) to a high level (e.g., a second level or a turn-on level). Therefore, the first transistor M1 and the fourth transistor M4 may be turned on.

In the data input period DIN, a data line voltage VDL may be transmitted to the third pixel PX3 through the data line DL. The data line voltage VDL may correspond to one of first to k-th voltages V1 to Vk. The data line voltage VDL is transmitted to the gate of the second transistor M2 through the first transistor M1 and may be charged in the first capacitor C1. Therefore, the second transistor M2 may be turned on.

In the data input period DIN, a voltage of the LCG line LL may be adjusted to a low current generation voltage VLCG (e.g., a voltage of a third level). The low current generation voltage VLCG may have a voltage level between the low level and the high level. That is, the low current generation voltage VLCG may be lower than the power supply voltage ELVDD.

In an embodiment, the low current generation voltage VLCG in the data input period DIN in FIG. 10 may be equal to or less than the data line voltage VDL. This may mean that the low current generation voltage VLCG is a voltage that makes a current IM3 of the third transistor M3 equal to or less than a current IM2 of the second transistor M2 (IM2≥IM3).

The low current generation voltage VLCG may be transmitted to the third pixel PX3 through the LCG line LL. The low current generation voltage VLCG is transmitted to the gate of the third transistor M3 through the fourth transistor M4 and may be charged in the second capacitor C2. Therefore, the third transistor M3 may be turned on.

In a display period DP, the voltage of the scan line SC may be adjusted from the high level to the low level. Therefore, the first transistor M1 and the fourth transistor M4 are turned off, and the voltages charged in the first capacitor C1 and the second capacitor C2 may be maintained.

In the display period DP, the voltage of the LCG line LL may be adjusted from the low current generation voltage VLCG to the low level. In an embodiment, in the display period DP, the voltage of the LCG line LL may be maintained as the low current generation voltage VLCG.

As described above, when expressing a low grayscale, in the data input period DIN and the display period DP, the third transistor M3 is turned on, and the current IM3 may flow through the third transistor M3.

The current IM2 of the second transistor M2 may be provided to the organic light-emitting diode OLED and the third transistor M3. That is, the current IM2 of the second transistor M2 may be equal to the sum of a current IOLED of the organic light-emitting diode OLED and the current IM3 of the third transistor M3. Therefore, the current IOLED of the organic light-emitting diode OLED may be determined by a difference between the current IM2 of the second transistor M2 and the current IM3 of the third transistor M3.

Meanwhile, when expressing a high grayscale, in the data input period DIN and the display period DP, the voltage of the LCG line LL may be maintained at the low level. Therefore, the third transistor M3 maintains the turn-off state, and the current IM3 may not flow through the third transistor M3.

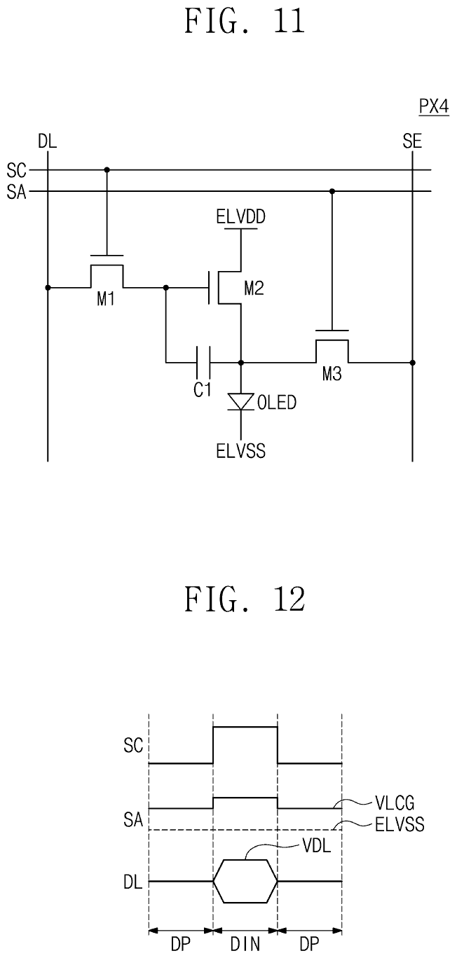

FIG. 11 illustrates an example of a fourth pixel. Referring to FIG. 1 and FIG. 11, a fourth pixel PX4 may include a first transistor M1 including a gate connected to a scan line SC, a first terminal connected to a data line DL, and a second terminal.

The fourth pixel PX4 may further include a second transistor M2 including a gate connected to the second terminal of the first transistor M1, a first terminal connected to a power node to which a power supply voltage ELVDD is supplied, and a second terminal.

The fourth pixel PX4 may further include a third transistor M3 including a gate connected to a control line SA, a first terminal connected to the second terminal of the second transistor M2, and a second terminal connected to an external line SE. The external line SE may output a voltage or a current within the fourth pixel PX4 to the outside of the pixel array 110. Different external lines may be provided for columns of the pixels PX. For example, the external line SE may be provided to the timing control block 150 or to a separate logic that is separate from the timing control block 150.

The fourth pixel PX4 may further include a first capacitor C1 connected between the second terminal of the first transistor M1 and the second terminal of the second transistor M2. The fourth pixel PX4 may further include an organic light-emitting diode OLED connected between the second terminal of the second transistor M2 and a first ground node to which a ground voltage ELVSS is supplied.

In an embodiment, the fourth pixel PX4 may be a circuit with a built-in external compensation function to compensate for changes in a threshold voltage of the second transistor M2 due to process variations.

FIG. 12 illustrates an example of signals for controlling the fourth pixel of FIG. 11 to express a low grayscale. Referring to FIGS. 1, 11, and 12, in a data input period DIN, that is, when a row of the fourth pixel PX4 is selected, a voltage of the scan line SC may be adjusted from a low level (e.g., a first level or a turn-off level) to a high level (e.g., a second level or a turn-on level). Therefore, the first transistor M1 may be turned on.

In the data input period DIN, that is, when the row of the fourth pixel PX4 is selected, a voltage of the control line SA may be adjusted to the high level. Therefore, the third transistor M3 may be turned on.

In the data input period DIN, a data line voltage VDL may be transmitted to the fourth pixel PX4 through the data line DL. The data line voltage VDL is transmitted to the gate of the second transistor M2 through the first transistor M1, and the second transistor M2 may be turned on.

In the data input period DIN, the external line SE may provide an initialization voltage VINI to the fourth pixel PX4. The initialization voltage VINI may be a voltage within a range including the ground voltage ELVSS and the power supply voltage ELVDD, a voltage lower than the ground voltage ELVSS, or a voltage higher than the power supply voltage ELVDD. The initialization voltage VINI may be transmitted to the second terminal of the second transistor M2 through the third transistor M3. A difference between a gate voltage and a voltage of the second terminal of the second transistor M2 may be maintained as a threshold voltage of the second transistor M2. A voltage charged in the first capacitor C1 may reflect the threshold voltage of the second transistor M2. Therefore, in the pixels PX, the variation in threshold voltages of the second transistors M2 due to process variations may be compensated for.

In a display period DP, the voltage of the scan line SC may be adjusted from the high level to the low level. Therefore, the first transistor M1 is turned off, and the voltage charged in the first capacitor C1 may be maintained.

In the display period DP, the voltage of the control line SA may be adjusted to a low current generation voltage VLCG (e.g., a voltage of a third level). The low current generation voltage VLCG may have a voltage level between the low level and the high level. That is, the low current generation voltage VLCG may be higher than the ground voltage ELVSS. Therefore, the third transistor M3 may maintain the turn-on state.

In the display period DP, the external line SE may provide a ground voltage VSS to the fourth pixel PX4. A current IM3 of the third transistor M3 may be transmitted to the outside (e.g., to a device outside the pixel array 110 or the display device 100) through the external line SE. In an embodiment, the ground voltage VSS may have a negative potential lower than 0V or a positive potential higher than 0V. In an embodiment, the ground voltage VSS may have the same potential as the ground voltage ELVSS. In an embodiment, the ground voltage VSS may have a different potential from the ground voltage ELVSS.

A current IM2 of the second transistor M2 may be provided to the organic light-emitting diode OLED and the third transistor M3. That is, the current IM2 of the second transistor M2 may be equal to the sum of a current IOLED of the organic light-emitting diode OLED and the current IM3 of the third transistor M3. Therefore, the current IOLED of the organic light-emitting diode OLED may be determined by a difference between the current IM2 of the second transistor M2 and the current IM3 of the third transistor M3.

In the above embodiments, components according to the present disclosure are described by using the terms “first”, “second”, “third”, and the like. However, the terms “first”, “second”, “third”, and the like may be used to distinguish components from each other and do not limit the present disclosure. For example, the terms “first”, “second”, “third”, and the like do not involve an order or a numerical meaning of any form.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure.

The display device 100 according to the present disclosure may accurately express a low grayscale and may implement a pixel circuit that is robust against noise.

The display device 100 according to the present disclosure can minimize a difference in power consumption while adding functionality. In addition, the display device 100 may be applied to existing external compensation circuits and may have a wide dynamic range while minimizing additional area. As a result, a contrast ratio is increased, enabling implementation of ultra-high-definition display.

What is claimed is:

1. A pixel circuit comprising:
a first transistor including a gate connected to a scan line, a first terminal connected to a data line, and a second terminal;
a second transistor including a gate connected to the second terminal of the first transistor, a first terminal connected to a power node to which a power supply voltage is supplied, and a second terminal;
a third transistor including a gate, a first terminal connected to the second terminal of the second transistor, and a second terminal;
a first capacitor connected between the second terminal of the first transistor and the second terminal of the second transistor; and
an organic light-emitting diode (OLED) connected between the second terminal of the second transistor and a first ground node,
wherein a current of the OLED is determined by a difference between a current of the second transistor and a current of the third transistor.

2. The pixel circuit of claim 1, wherein the gate of the third transistor receives a low current generation voltage.

3. The pixel circuit of claim 2, wherein a voltage of the scan line is adjusted to a first voltage in a first period and adjusted to a second voltage in a second period, and
wherein the low current generation voltage is maintained at a third voltage in the first period and the second period.

4. The pixel circuit of claim 3, wherein the third voltage has a level between a level of the first voltage and a level of the second voltage.

5. The pixel circuit of claim 4, wherein in the first period, the first transistor, the second transistor, and the third transistor are turned on, and
wherein in the second period, the first transistor is turned off, and the second transistor and the third transistor are turned on.

6. The pixel circuit of claim 1, wherein the pixel circuit further comprises:
a fourth transistor including a gate connected to the scan line, a first terminal connected to an LCG line, and a second terminal connected to the gate of the third transistor; and
a second capacitor connected between the second terminal of the third transistor and the second terminal of the fourth transistor.

7. The pixel circuit of claim 6, wherein the third transistor operates based on a voltage of the LCG line.

8. The pixel circuit of claim 7, wherein a voltage of the scan line is adjusted to a first voltage in a first period and adjusted to a second voltage in a second period, and
wherein a voltage of the LCG line is adjusted to a third voltage in the first period and adjusted to the second voltage in the second period.

9. The pixel circuit of claim 8, wherein the third voltage has a level between a level of the first voltage and a level of the second voltage.

10. The pixel circuit of claim 9,
wherein in the first period, the first transistor, the second transistor, the third transistor, and the fourth transistor are turned on, and
wherein in the second period, the first transistor and the fourth transistor are turned off, and the second transistor and the third transistor are turned on.

11. The pixel circuit of claim 1, wherein the gate of the third transistor is connected to a control line, and
wherein the second terminal of the third transistor is connected to an external line.

12. The pixel circuit of claim 11, wherein a voltage of the scan line is adjusted to a first voltage in a first period and adjusted to a second voltage in a second period,
wherein a voltage of the control line is adjusted to the first voltage in the first period and adjusted to a third voltage in the second period, and
wherein a voltage of the external line is adjusted to a fourth voltage in the first period and adjusted to the second voltage in the second period.

13. The pixel circuit of claim 12, wherein the third voltage has a level between a level of the first voltage and a level of the second voltage.

14. The pixel circuit of claim 13, wherein in the first period, the first transistor, the second transistor, and the third transistor are turned on, and
wherein in the second period, the first transistor is turned off, and the second transistor and the third transistor are turned on.

15. The pixel circuit of claim 14, wherein in the second period, a current of the third transistor is output externally through the external line.

16. A display device comprising:
pixels arranged in rows and columns;
a gate driver connected to the rows of the pixels through first conductive lines and second conductive lines; and
a data driver connected to the columns of the pixels through third conductive lines,
wherein each of the pixels comprises:
a first transistor including a gate connected to a corresponding first conductive line among the first conductive lines, a first terminal connected to a corresponding third conductive line among the third conductive lines, and a second terminal;
a second transistor including a gate connected to the second terminal of the first transistor, a first terminal connected to a power node to which a power supply voltage is supplied, and a second terminal;
a third transistor including a gate, a first terminal connected to the second terminal of the second transistor, and a second terminal;
a first capacitor connected between the second terminal of the first transistor and the second terminal of the second transistor; and
an organic light-emitting diode (OLED) connected between the second terminal of the second transistor and a first ground node,
wherein a current of the OLED is determined by a difference between a current of the second transistor and a current of the third transistor.

17. The display device of claim 16, wherein the gate of the third transistor receives a low current generation voltage,
wherein a voltage of the corresponding first conductive line among the first conductive lines is adjusted to a first voltage in a first period and adjusted to a second voltage in a second period, and
wherein the low current generation voltage is maintained at a third voltage in the first period and the second period.

18. The display device of claim 16, wherein the data driver is further connected to the columns of the pixels through fourth conductive lines.

19. The display device of claim 18,
wherein each of the pixels further comprises:
a fourth transistor including a gate connected to the corresponding first conductive line among the first conductive lines, a first terminal connected to a corresponding fourth conductive line among the fourth conductive lines, and a second terminal connected to the gate of the third transistor; and
a second capacitor connected between the second terminal of the third transistor and the second terminal of the fourth transistor,
wherein a voltage of the corresponding first conductive line among the first conductive lines is adjusted to a first voltage in a first period and adjusted to a second voltage in a second period, and
wherein a voltage of the corresponding fourth conductive line among the fourth conductive lines is adjusted to a third voltage in the first period and adjusted to the second voltage in the second period.

20. The display device of claim 18, wherein the gate of the third transistor is connected to a corresponding second conductive line among the second conductive lines,
wherein the second terminal of the third transistor is connected to a corresponding fourth conductive line among the fourth conductive lines,
wherein a voltage of the corresponding first conductive line among the first conductive lines is adjusted to a first voltage in a first period and adjusted to a second voltage in a second period,
wherein a voltage of the corresponding second conductive line among the second conductive lines is adjusted to the first voltage in the first period and adjusted to a third voltage in the second period, and
wherein a voltage of the corresponding fourth conductive line among the fourth conductive lines is adjusted to a fourth voltage in the first period and adjusted to the second voltage in the second period.
